(19) United States
(12) Patent Application Publication
(10) Pub. No.: US 2009/0148753 A1
(43) Pub. Date: Jun. 11, 2009

(54) CAP ASSEMBLY AND SECONDARY BATTERY HAVING THE SAME

(75) Inventor: Yoon-Cheol JEON, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/329,017

(22) Filed: Dec. 5, 2008

(30) Foreign Application Priority Data
Dec. 7, 2007 (KR) 2007-126904

(51) Int. Cl. H01M 2/12

(52) U.S. Cl. 429/53

(57) ABSTRACT

A cap assembly and a secondary battery having the same, the cap assembly including: a safety vent having a protrusion that extends at a predetermined angle of inclination; a cap down having a hole through which the protrusion extends; an insulating plate positioned between the cap down and the safety vent; a sub plate disposed between the cap down and the safety vent, and connected to the protrusion; and a cap up electrically disposed upon the safety vent. The sub plate includes grooves disposed around the protrusion

### CROSS-REFERENCE TO RELATED APPLICATION

This application claims the benefit of Korean Patent Application No. 2007-126904, filed Dec. 7, 2007, in the Korean Intellectual Property Office, the disclosure of which is hereby incorporated herein by reference in its entirety.

### BACKGROUND OF THE INVENTION

1. Field of the Invention

Aspects of the present invention relate to a cap assembly and a secondary battery having the same, and more particularly, to a cap assembly that is capable of preventing an increase of actuating pressure of a safety vent, due to the connection of an electrode assembly to the safety vent, by changing the shape of the safety vent and the shape of a connection unit that electrically connects the electrode assembly to the safety vent.

2. Description of the Related Art

Compact, portable, electronic/electric products, such as cellular phones, notebook computers, camcorders, and the like, have been actively developed and produced. Portable electronic/electric products generally include a battery pack as a portable power supply. A battery pack typically includes a secondary battery, such as a nickel-cadmium (Ni—Cd) battery, a nickel-hydrogen (Ni-MH) battery, or a lithium (Li) battery.

Lithium secondary batteries are widely used in portable electronic/electric products because they have a three times higher operating voltage than nickel-cadmium batteries or nickel-hydrogen batteries, and also have a higher energy density per unit weight. Lithium secondary batteries are classified as lithium ion batteries, which use liquid electrolytes, and lithium polymer batteries, which use polymer electrolytes. Lithium secondary batteries can also be classified as cylindrical-type, square-type, or pouch-type, according to the shape thereof.

A secondary battery generally comprises an electrode assembly, a can to house the electrode assembly and an electrolyte, and a cap assembly to seal an opening of the can. The electrode assembly comprises: a positive electrode plate including a positive electrode collector coated with an active positive electrode material and a positive electrode tab electrically connected to one side of the positive electrode collector; a negative electrode plate including a negative electrode collector coated with an active negative electrode material and a negative electrode tab electrically connected to one side of the negative electrode collector; and a separator positioned between the positive electrode plate and the negative electrode plate.

The cap assembly is combined with the opening of the can, so as to seal the can. The cap assembly comprises a cap up, a safety vent, a current interrupt device (CID), and a gasket. The cap up can operate as an external terminal. The safety vent is electrically connected to the positive electrode plate or the negative electrode plate. When an internal pressure, due to gas generated from the electrode assembly, is more than a predetermined level, the safety vent deforms or ruptures to discharge the gas to the outside. The current interrupt device is positioned on the safety vent. When the safety vent deforms or ruptures, the current interrupt device interrupts current flow through the battery. The gasket insulates the cap assembly from the can. To prevent an over-current from flowing between the electrode assembly and the external terminal, the cap assembly may further comprise a positive temperature coefficient (PTC) thermistor, which is positioned between the current interrupt device and the cap up, or between the safety vent and the current interrupt device.

To electrically connect the safety vent to the electrode assembly, a protrusion of the safety vent protrudes towards the electrode assembly. The protrusion is welded, by ultrasonic welding or resistance welding, to an electrical connection unit, such as an electrode tab that is electrically connected to the positive electrode plate or negative electrode plate. Since the bonding of the safety vent and the electrical connection can increase the pressure required to break the safety vent, problems can occur. Accordingly, the safety of the secondary battery can be reduced.

### SUMMARY OF THE INVENTION

Aspects of the present invention provide a cap assembly and a secondary battery having the same. The cap assembly prevents an increase of actuating pressure of a safety vent, resulting from electrically connecting an electrode assembly of the secondary battery to the safety vent, by changing the shape of the safety vent and the shape of a connection unit that electrically connects the electrode assembly to the safety vent.

Aspects of the present invention provide a cap assembly comprising: a safety vent including a protrusion that protrudes at a predetermined angle of inclination; a cap down including a central hole through which the protrusion extends; an insulating plate positioned between the cap down and the safety vent; a sub plate disposed between the cap down and the safety vent, and connected to the protrusion of the safety vent; and a cap up to electrically connect the safety vent to an external device. The sub plate includes one or more grooves formed adjacent to the protrusion.

Aspects of the present invention provide a secondary battery comprising: an electrode assembly including a positive electrode plate, a negative electrode plate, and a separator between the positive plate and the negative electrode plate; a can to house the electrode assembly; a cap assembly to seal the can, including a safety vent with a protrusion that extends toward the electrode assembly at a predetermined angle of inclination; and a connection unit that is connected to the protrusion and the electrode assembly. The connection unit includes grooves formed adjacent to the protrusion.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a secondary battery, according to a first exemplary embodiment of the present invention;

FIG. 2A is a sectional view of the secondary battery of FIG. 1;

FIG. 2B is an enlarged view of part “A” shown in FIG. 2A;

FIG. 3 is a graph illustrating tensile stress, according to an angle of inclination at which a safety vent protrudes, in the secondary battery according to the first exemplary embodiment of the present invention;

FIG. 4A is a sectional view of a secondary battery, according to a second exemplary embodiment of the present invention; and

FIG. 4B is an enlarged view of part “B” shown in FIG. 4A.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures. As referred to herein, when a first element is said to be disposed “on”, or adjacent to, a second element, the first element can directly contact the second element, or can be separated from the second element by one or more other elements can be located therebetween. In contrast, when an element is referred to as being disposed “directly on” another element, there are no intervening elements present. As used herein, the term “and/or” includes any and all combinations of one or more of the associated listed items.

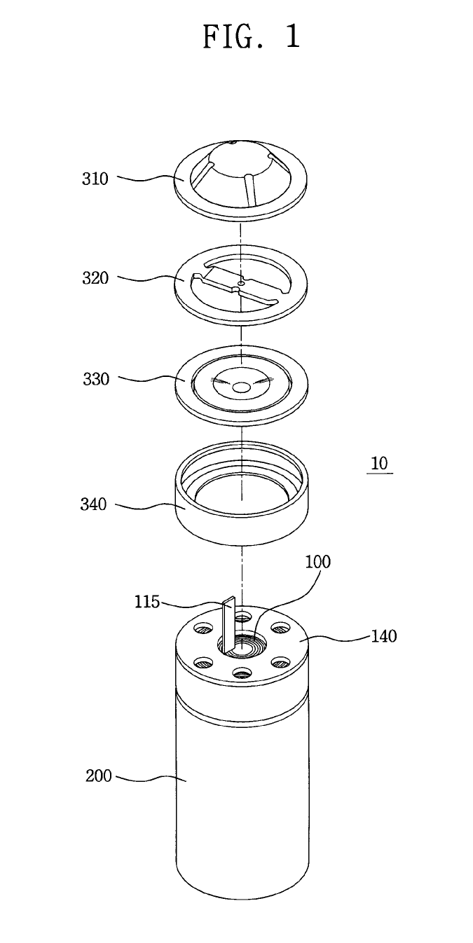

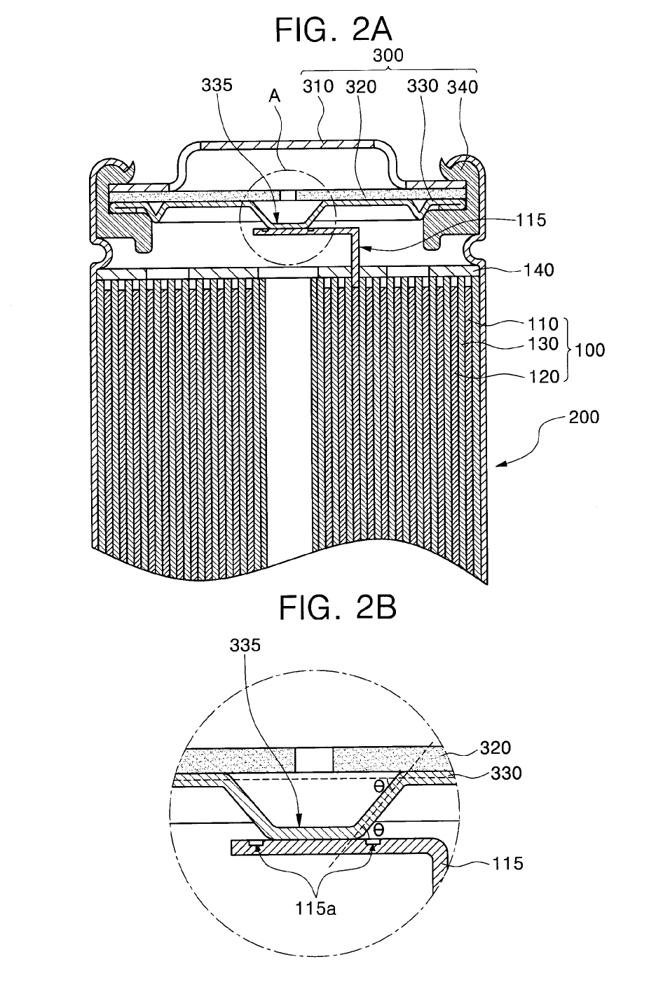

FIG. 1 is an exploded perspective view of a secondary battery 10, according to a first exemplary embodiment of the present invention, FIG. 2A is a sectional view of the secondary battery 10, and FIG. 2B is an enlarged view of part “A” shown in FIG. 2A. With reference to FIGS. 1, 2A, and 2B, the secondary battery 10 comprises: an electrode assembly 100; a can 200 to house the electrode assembly 100 and an electrolyte (not shown); and a cap assembly 300 to seal the can 200. The cap assembly 300 includes a safety vent 330 including a protrusion 335 that extends toward the electrode assembly 100, at a predetermined angle θ, and a connection unit 115 that is connected to the protrusion 335 and the electrode assembly 100.

The electrode assembly 100 comprises a positive electrode plate 110, a negative electrode plate 120, and a separator 130 positioned between the positive electrode plate 110 and the negative electrode plate 120. The positive electrode plate 110 includes a positive electrode collector (not shown) coated with an active positive electrode material (not shown) and a positive electrode tab (not shown) electrically connected to one side of the positive electrode collector. The negative electrode plate 120 includes a negative electrode collector (not shown) coated with an active negative electrode material (not shown) and a negative electrode tab (not shown) electrically connected to one side of the negative electrode collector. The electrode assembly 100 may further comprise a top insulating plate 140 positioned on top of the electrode assembly 100, to prevent the vertical movements of the electrode assembly 100, and to prevent a short between the electrode assembly 100 and the cap assembly 300.

The active positive electrode material may include lithium-containing transition metal oxides, such as LiCoO₂, LiNiO₂, LiMnO₂, LiMn₂O₄, or LiNi_{1-x-y}COₓM_{y}O₂ (wherein, 0≦x≦1, 0≦y≦1 0≦x+y≦1, and M is a metal such as Al, Sr, Mg, or La), or lithium chalcogenide compounds. The active negative electrode material may use carbon materials, such as a crystalline carbon, an amorphous carbon, a carbon complex, a carbon fiber, and the like, lithium metals, or lithium alloys.

The positive electrode collector or negative electrode collector may be formed of stainless steel, nickel, copper, aluminum, or an alloy thereof. For example, the positive electrode collector may be formed of aluminum or an aluminum alloy, and the negative electrode collector may be formed of copper or a copper alloy.

The separator 130 prevents a short circuit between the positive electrode plate 110 and the negative electrode plate 120 and is selectively permeable to lithium ions. The separator 130 may be formed of a polyolefin-based polymer layer, such as polyethylene (PE), polypropylene (PP), and the like, or may be formed of multiple layers thereof.

An opening is formed in the top of the can 200, to receive the electrode assembly and the electrolyte. The can 200 may be formed of a metal, such as aluminum, an aluminum alloy, stainless steel, and the like. The can 200 may be connected to the positive electrode plate 110 or the negative electrode plate 120, to operate as an electrode terminal.

Lithium ions generated in the positive electrode plate 110 and the negative electrode plate 120, by an electrochemical reaction, can move through the electrolyte. The electrolyte may be a non-aqueous organic electrolyte, which is a mixture of lithium salts and high-purity organic solvents, or it may be a polymer electrolyte.

The cap assembly 300 is combined with the opening of the can 200, to seal the can 200. The cap assembly 300 comprises a cap up 310, the safety vent 330, a current interrupt device (CID) 320, and a gasket 340. The gasket 340 insulates the cap assembly 300 from the can 200, and more firmly seals the can 200. The cap assembly 300 may further comprise a positive temperature coefficient (PTC) thermistor (not shown), which can be positioned between the current interrupt device 320 and the cap up 310, or between the safety vent 330 and the current interrupt device 320. The PTC thermistor prevents overcharging and over discharging of the electrode assembly 100.

When an internal pressure of the secondary battery 10 is increased beyond a certain level, due to a gas generated by the electrode assembly 100, the safety vent 330 deforms or ruptures to discharge the gas to the outside. The safety vent 330 includes a protrusion 335 that extends toward the electrode assembly 100. The protrusion 335 protrudes from the safety vent 330 at the predetermined angle θ, with respect to a horizontal plane of the safety vent 330, as illustrated in FIG. 1B.

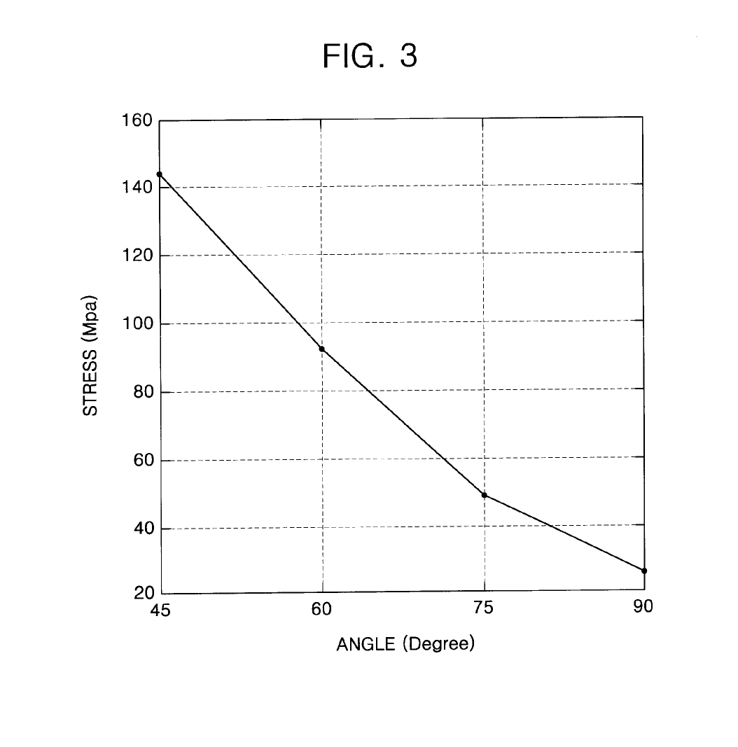

FIG. 3 is a graph illustrating tensile stresses applied to the safety vent 330, according to the angle of inclination θ of the protrusion 335. With reference to FIG. 3, the tensile stress applied to the safety vent 330 decreases as the angle of inclination θ increases. FIG. 3 does not illustrate the tensile stress in the case where the angle of inclination θ is below 45°. However, considering that the material used for the safety vent 330 is generally nickel, aluminum, or an alloy thereof, and that the minimum yield stress of such materials is 145 Mpa, when the protrusion 335 of the safety vent 330 protrudes at an angle of inclination of below 45°, the safety vent 330 may undesirably deform or rupture, irrespective of the internal pressure.

In FIG. 3, when the angle of inclination θ is above 75°, the tensile stress applied to the safety vent 330 is below 50 Mpa. When the tensile stress applied to the safety vent 330 is below 50 Mpa, the stress applied to deform or rupture the protrusion is below 10 Mpa, therefore, the safety vent 330 generally cannot offset the bonding intensity between the safety vent 330 and the connection unit 115, which is strengthened by ultrasonic welding or resistance welding. Thus, the protrusion 335 may have the angle of inclination θ that is within 45° to 75°, based on the horizontal plane of the safety vent 330.

The connection unit 115 is electrically connected to the positive electrode plate 110, or negative electrode plate 120, and the protrusion 335. The connection unit 115 includes one or more grooves 115a formed adjacent to a contact region of the protrusion 335 and the connection unit 115. The connection unit 115 may be a lead tab that is electrically connected to a positive/negative electrode tab of the positive/negative electrode plates 110 and 120, or it may be the positive electrode tab or the negative electrode tab.

In FIGS. 2A and 2B, the grooves 115a of the connection unit 115 face the safety vent 330 and have rectangular cross-sections. The grooves 115a may be formed on one or both sides of the connection unit 115. The grooves 115a may in some embodiments have semi-circular or triangular cross sections.

The grooves 115a may be symmetrically disposed around opposing sides of the protrusion 335. The protrusion 335 may be conical or prismatic in shape. For example, the protrusion 335 can be frustum-shaped.

The protrusion 335 extends toward the electrode assembly 100 at the predetermined angle of inclination, so that the tensile stress and the stress resulting from the internal pressure are applied to the safety vent 330 by the protrusion 335. The grooves 115a are formed on the connection unit 115, around a connection point of the connection unit 115 and the protrusion 335. Accordingly, when the protrusion 335 is electrically connected to the connection unit 115, by the welding process, the secondary battery 10 prevents the actuating pressure of the safety vent 330 from increasing, due to the bonding intensity of the safety vent 330 and the connection unit 115.

### Second Exemplary Embodiment

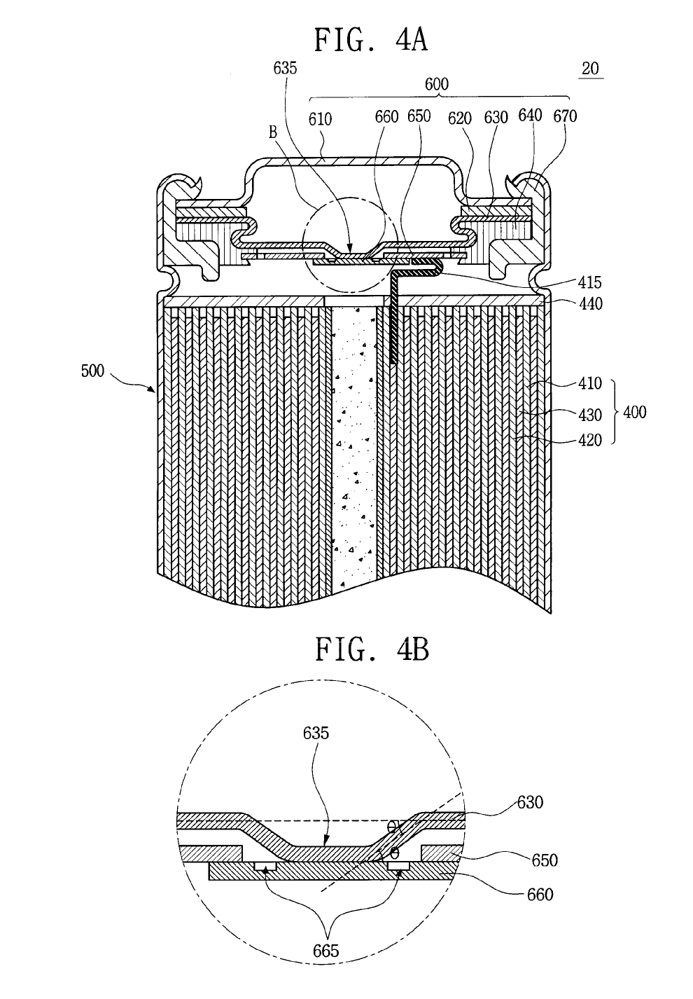

FIG. 4A is a sectional view of a secondary battery 20, according to a second exemplary embodiment of the present invention, and FIG. 4B is an enlarged view of part “B” shown in FIG. 4A. With reference to FIGS. 4A and 4B, the secondary battery 20 comprises: an electrode assembly 400; a can 500 to house the electrode assembly 400 and an electrolyte (not shown); a cap assembly 600 to seal the can 500; and a lead tab 415 electrically connecting the cap assembly 600 and the electrode assembly 400. The cap assembly includes a safety vent 630 including a protrusion 635 that extends toward the electrode assembly 400 at a predetermined angle θ. The secondary battery 20 may further comprise a top insulating plate 440 positioned on top of the electrode assembly 400, to prevent vertical movements of the electrode assembly 400 and to prevent a short between the electrode assembly 400 and the cap assembly 600.

The electrode assembly 400 comprises: a positive electrode plate 410 including a positive electrode collector (not shown) coated with an active positive electrode material (not shown); a positive electrode tab (not shown) electrically connected to one side of the positive electrode collector; a negative electrode plate 420 including a negative electrode collector (not shown) coated with an active negative electrode material (not shown); a negative electrode tab (not shown) electrically connected to one side of the negative electrode collector; and a separator 430 positioned between the positive electrode plate 410 and the negative electrode plate 420. No further description of the electrode assembly 400 and the can 500 of the secondary battery 20 will be presented, because they are similar to the electrode assembly 100 and the can 200 of the secondary battery 10.

The lead tab 415 may be the positive electrode tab or the negative electrode tab. In FIG. 4A, the lead tab 415 contacts a cap down 650 of the cap assembly 600. However, the lead tab 415 may contact a sub plate 660 of the cap assembly 600.

The cap assembly 600 is combined with an opening of the can 500, to seal the can 500. The cap assembly 300 comprises: a cap up 610 that can be electrically connected to an external terminal; a safety vent 630 that can be deformed or ruptured by an internal pressure, which includes a protrusion 635 protruding at a predetermined angle θ; a cap down 650 including a hole through which the protrusion 635 extends, electrically connected to the lead tab 415; an insulating plate 640 positioned between the cap down 650 and the safety vent 630; a sub plate 660 disposed between the cap down 650 and the safety vent 630, which is connected to the protrusion 635 of the safety vent 630; and a gasket 670 to insulate the cap assembly 600 from the can 500, to more firmly seal the can 500. The cap assembly 600 may further comprise a positive temperature coefficient (PTC) thermistor 620 positioned between the safety vent 630 and the cap up 610, to prevent the electrode assembly 400 from being overcharged or over discharged.

When the internal pressure is more than a predetermined level, due to gas generated by the electrode assembly 400, the safety vent 630 deforms, or ruptures to allow the gas to be discharged to the outside. In the safety vent 630, the protrusion 635 protrudes toward the electrode assembly 400 at the predetermined angle of inclination θ, with respect to a horizontal plane of the safety vent 630. The predetermined angle of inclination θ may be in the range of 45° to 75°.

The sub plate 660 is electrically connected to the positive electrode plate 410 or negative electrode plate 420 of the electrode assembly 400 and contacts the protrusion 635. The sub plate 660 includes one or more grooves 665. The grooves can be disposed around a contact point of the sub plate 660 and the protrusion 635.

In FIGS. 4A and 4B, the grooves 665 of the sub plate 660 are formed to face the safety vent 630. However, the grooves 665 may be formed on one or both sides of the sub plate 660. The grooves 665 may be polygonal, rectangular, semicircular, or triangular in cross section, for example. The grooves 665 may be symmetrically disposed around the protrusion 635. The protrusion 635 may be in a pyramidal or conical, for example, the protrusion 635 can be frustum-shaped. When the protrusion 635 is electrically connected to the sub plate 660, by welding, the secondary battery 20 prevents the actuating pressure of the safety vent 630 from being altered by the welding.

In the secondary battery 20, the protrusion 635 protrudes towards the electrode assembly 400 at the predetermined angle of inclination, so as to contact the connection unit 660. One or more of the grooves 665 are formed around where the connection unit 660 is connected to the protrusion 635. The bonding of the safety vent 630 and the connection unit 660 reinforces the safety vent 630, but is offset by the grooves 665 formed in the connection unit 660 and/or the angle of the protrusion 635, so that the actuating pressure of the safety vent 630 is not increased.

Although a few exemplary embodiments of the present invention have been shown and described, it would be appreciated by those skilled in the art that changes may be made in these embodiments, without departing from the principles and spirit of the invention, the scope of which is defined in the claims and their equivalents.

What is claimed is:

1. A cap assembly comprising:
a cap up;
a safety vent disposed on the cap up, comprising a protrusion that extends at an angle of inclination from the safety vent;
a cap down disposed on the safety vent, having a central a hole through which the protrusion extends;
an insulating plate disposed between the cap down and the safety vent; and
a sub plate disposed on the cap down, connected to the protrusion of the safety vent, the sub plate including a groove disposed adjacent to the protrusion.

2. The cap assembly according to claim 1, wherein the angle of inclination is from 45° to 75°, based on a horizontal plane of the safety vent.

3. The cap assembly according to claim 1, wherein the groove formed on a surface of the sub plate that faces the safety vent, or is formed on a surface of the sub plate that faces away from the safety vent.

4. The cap assembly according to claim 1, wherein the sub plate includes a plurality of the grooves, which are symmetrically disposed around the protrusion.

5. The cap assembly according to claim 1, wherein the groove is semicircular or polygonal, in cross-section.

6. The cap assembly according to claim 1, wherein the protrusion is welded to the sub plate by ultrasonic welding or resistance welding.

7. The cap assembly according to claim 1, further comprising: a positive temperature coefficient thermistor, disposed between the safety vent and the cap up.

8. The cap assembly according to claim 1, wherein the protrusion is frustum-shaped.

9. A secondary battery comprising:
an electrode assembly comprising a positive electrode plate, a negative electrode plate, and a separator disposed between the positive electrode plate and the negative electrode plate;
a can to house the electrode assembly;
a cap assembly to seal an opening of the can, comprising a safety vent comprising a protrusion that extends toward the electrode assembly at a predetermined angle of inclination; and
a connection unit connected to the protrusion and the electrode assembly, the connection unit comprising a groove formed adjacent to the protrusion.

10. The secondary battery according to claim 9, wherein the angle of inclination is from 45° to 75°, based on a horizontal plane of the safety vent.

11. The secondary battery according to claim 9, wherein the groove is formed on a surface of the sub plate that faces the vent, or is formed on a surface of the sub plate that faces away from the safety vent.

12. The secondary battery according to claim 9, wherein the groove is semicircular, triangular, or polygonal, in cross-section.

13. The secondary battery according to claim 9, wherein the sub plate includes a plurality of the grooves, which are symmetrically disposed around the protrusion.

14. The secondary battery according to claim 9, wherein the connection unit is a lead tab electrically connected to the positive electrode plate or the negative electrode plate.

15. The secondary battery according to claim 14, wherein the cap assembly comprises:
a cap up disposed on the safety vent; and
a current interrupt device disposed between the safety vent and the cap up.

16. The secondary battery according to claim 15, wherein the cap assembly further comprises: a positive temperature coefficient thermistor disposed between the current interrupt device and the cap up, or between the safety vent and the current interrupt device.

17. The secondary battery according to claim 9, wherein the connection unit is a positive electrode tab electrically connected to the positive electrode plate, or is a negative electrode tab electrically connected to the negative electrode plate.

18. The secondary battery according to claim 9, wherein the cap assembly comprises:
a cap down having a central hole through which the protrusion extends, electrically connected to the electrode assembly;
an insulating plate disposed between the cap down and the safety vent; and
a cap up disposed on the safety vent,
wherein the connection unit is a sub plate disposed between the cap down and the safety vent.

19. The secondary battery according to claim 18, wherein the cap assembly further comprises: a positive temperature coefficient thermistor disposed between the safety vent and the cap up.

20. The secondary battery according to claim 9, wherein the protrusion is welded to the connection unit by ultrasonic welding or resistance welding.

21. The secondary battery according to claim 9, wherein the protrusion is frustum-shaped.

22. The cap assembly according to claim 1, wherein the sub plate includes a plurality of the grooves, which are symmetrically disposed around the protrusion, on opposing sides of the sub plate.

23. The secondary battery according to claim 9, wherein the sub plate includes a plurality of the grooves, which are symmetrically disposed around the protrusion, on opposing sides of the sub plate.

24. A secondary battery according to claim 9, wherein the cap assembly comprises a cap up, a safety vent disposed on the cap up, comprising a protrusion that extends at an angle of inclination of 45° to 75°, with respect to a horizontal plane of the safety vent, a cap down disposed on the safety vent, having a central a hole through which the protrusion extends and an insulating plate disposed between the cap down and the safety vent, wherein the connection unit is welded to the protrusion of the safety vent,
wherein the grooves and the angle of inclination compensate for an increased tensile strength of the safety vent, resulting from the welding of the protrusion to the sub plate, so as to reduce an internal pressure required to deform the safety vent.
